(19) United States
(12) Patent Application Publication
(10) Pub. No.: US 2013/0135783 A1
(43) Pub. Date: May 30, 2013

(54) ARRESTER

(71) Applicants: Hiroki SAITO, Tokyo (JP); Koichi Akaso, Tokyo (JP)

(72) Inventors: Hiroki SAITO, Tokyo (JP); Koichi Akaso, Tokyo (JP)

(73) Assignee: Mitsubishi Electric Corporation, Chiyoda-ku (JP)

(21) Appl. No.: 13/468,654

(22) Filed: May 10, 2012

(30) Foreign Application Priority Data
Nov. 29, 2011 (JP) 2011-260474

(51) Int. Cl. H02H 1/00

(52) U.S. Cl. 361/127

(57) ABSTRACT

Without providing mechanical processed portions on a plurality of insulating rods arranged around zinc oxide elements, tightening pieces are respectively attached on both end portions of the insulating rod by being tightened. The tightening piece is arranged while being sandwiched by an electrode and a mounting plate, and the electrode and the mounting plate are fastened by a bolt in an axial direction of the insulating rod. With this configuration, the tightening piece is solidly fixed to the electrode by an axial force of the bolt.

### BACKGROUND OF THE INVENTION

1. Field of the Invention

The present invention relates to an arrester that is installed in an electrical power plant, an electrical power substation, or the like and is used for protecting electrical devices from an abnormal voltage generated in an electrical power system, and particularly to a polymer arrester that is a type to directly mold an internal element including a zinc oxide element with a polymer resin such as a silicon rubber.

2. Description of the Related Art

A polymer arrester of a type to directly mold an internal element including a zinc oxide element with a silicon rubber or the like is reinforced for improving mechanical strength by using an insulating support member such as FRP (Fiber Reinforced Plastics) arranged around stacked zinc oxide elements, and therefore it is an important issue how to fix the insulating support member with respect to an electrode.

In a polymer arrester described in Japanese Patent Application Laid-open No. 2003-332108, zinc oxide elements are stacked between a pair of support pieces, and the paired support pieces are coupled to each other via a plurality of insulating rods (insulating support members). An electrode is then connected to the support piece via a bolt. In a coupling portion of the insulating rod and the support piece, a groove portion is provided for fitting a part of the support piece into an end portion of the insulating rod.

In addition, in a polymer arrester described in Japanese Patent Application Laid-open No. 2010-027671, a drilled hole portion to pass a bolt is provided on an end portion of an insulating rod (an insulating support member) in order to fix the insulating rod to an electrode with a bolt.

However, in the polymer arrester described in Japanese Patent Application Laid-open No. 2003-332108, because the groove portion is provided on the end portion of the insulating rod, when a load is applied on the arrester, the load is concentrated on this groove portion. Therefore, when an excessive load is applied on the arrester, it may lead to breakage of the insulating rod starting from the groove portion (the mechanically processed portion) of the insulating rod.

Similarly, in the polymer arrester described in Japanese Patent Application Laid-open No. 2010-027671, because the drilled hole portion is provided on the insulating rod, when a load is applied on the arrester, the load is concentrated on the drilled hole portion (the mechanically processed portion). In this case, when an FRP rod is used as the insulating rod, for example, providing the drilled hole portion on the FRP rod may fracture glass fibers of the FRP. Therefore, the strength of the FRP is significantly decreased against a load generated in a direction of the glass fiber.

As described above, in the polymer arrester described in Japanese Patent Application Laid-open No. 2003-332108 and Japanese Patent Application Laid-open No. 2010-027671, when an excessive load is applied on the arrester, the load may lead to breakage of the insulating rod (the insulating support member) starting from the mechanically processed portion. Therefore, in order to provide an arrester having a large mechanical strength in a configuration of such a conventional polymer arrester, it is required to increase the diameter of the insulating rod or to increase the number of insulating rods to be installed, and this leads to an increase of the arrester in size and cost.

### SUMMARY OF THE INVENTION

It is an object of the present invention to at least partially solve the problems in the conventional technology.

There is provided an arrester according to an aspect of the present invention including: a serial member including stacked voltage nonlinear resistor elements and a pressing spring that is arranged at one end of the voltage nonlinear resistor elements and presses the voltage nonlinear resistor elements in its slacking direction; a plurality of insulating rods arranged around the serial member along the stacking direction each having a constant outer diameter, where end portions of each of the insulating rods are respectively fixed by being fitted into substantially cylindrical pieces each having a bottom and caulked by the pieces; a pair of mounting plates respectively arranged on both ends of the serial member in the stacking direction and sandwiching the serial member, where each of the mounting plates has a plurality of insertion holes each being formed in a stepped shape such that an end portion of the insulating rod is inserted through and one end portion of the piece on a side of the serial member is fitted; a pair of electrodes respectively arranged on both outer sides of the pair of mounting plates in the stacking direction, where each of the electrodes faces its corresponding mounting plate and is arranged separately from the mounting plate, and has a plurality of fitting holes into which other end portions of the pieces are respectively fitted; and a bolt that fastens in the stacking direction the mounting plate, in which the end portions of the insulating rods respectively inserted into the insertion holes and the one end portions of the pieces are respectively fitted into the insertion holes, and the electrode, which faces the mounting plate with the other end portions the pieces respectively fitted into the fitting holes, and tightens the pieces in the stacking direction in a state where the pieces are sandwiched between the electrode and the mounting plate.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a vertical cross-sectional view of a configuration of an arrester according to a first embodiment;

FIG. 2 is a horizontal cross-sectional view taken along a line A-A indicated by arrows in FIG. 1;

FIG. 3 is a vertical cross-sectional view of a configuration of an arrester according to a second embodiment;

FIG. 4 is a horizontal cross-sectional view taken along a line A-A indicated by arrows in FIG. 3;

FIG. 5 is a vertical cross-sectional view of a configuration of an arrester according to a third embodiment; and

FIG. 6 is a horizontal cross-sectional view taken along a line A-A indicated by arrows in FIG. 5.

### DETAILED DESCRIPTION OF THE PREFERRED EMBODIMENTS

Exemplary embodiments of an arrester according to the present invention will be explained below in detail with reference to the accompanying drawings. The present invention is not limited to the embodiments.

### First Embodiment

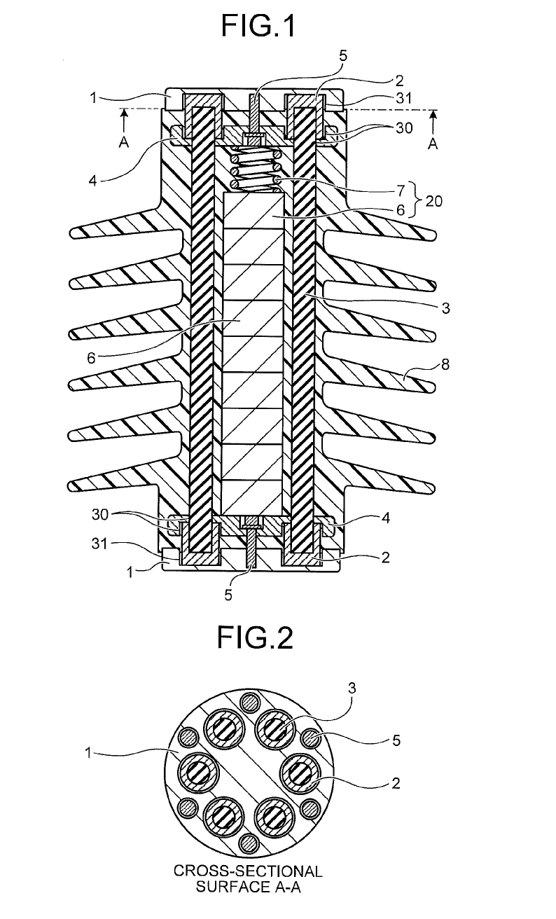

FIG. 1 is a vertical cross-sectional view of a configuration of an arrester according to a first embodiment of the present invention, and FIG. 2 is a horizontal cross-sectional view taken along a line A-A indicated by arrows in FIG. 1. As shown in FIGS. 1 and 2, in a center portion of the arrester, for example, a plurality of zinc oxide elements 6, which serve as voltage nonlinear resistor elements, are stacked to form a zinc oxide element block. The cross-sectional shape of the zinc oxide element 6 is a circular shape, for example. At one end of a direction of stacking the zinc oxide elements 6 (hereinafter, simply “stacking direction”), a pressing spring 7 is arranged in a compressed state, and presses the zinc oxide elements 6 in the stacking direction. This makes the zinc oxide elements 6 have close contact with each other. The zinc oxide elements 6 are fixed by a spring load of the pressing spring 7, so that it is possible to suppress a position offset of the zinc oxide elements 6 due to an impact at the time of transporting or the like. The stacked zinc oxide elements 6 and the pressing spring 7 constitute a serial member 20.

A mounting plate 4 is arranged at each end of the serial member 20 in the stacking direction. That is, a pair of mounting plates 4 is arranged to sandwich the serial member 20 in the stacking direction. The mounting plate 4 is formed with a metal plate of a circular shape, for example. An insertion hole 30 into which an insulating rod 3 is inserted is provided on the mounting plate 4. For example, the insertion hole 30 is provided at a regular interval in a circumferential direction of the mounting plate 4 according to the number of insulating rods 3 (for example, six insulating rods in the example shown in the drawings). The insertion hole 30 is formed in a stepped shape including a first inner diameter portion provided on the side of the serial member 20 with an inner diameter substantially the same as an outer diameter of the insulating rod 3 and a second inner diameter portion provided on a side of an electrode 1 being connected with the first inner diameter portion with an inner diameter larger than that of the first inner diameter portion. As described later, the second inner diameter portion is provided for fitting a tightening piece 2, where one end portion of the tightening piece 2 on the side of the serial member 20 is fitted into the second inner diameter portion.

A pair of electrodes 1 is arranged on respective sides of the pair of the mounting plates 4 in the stacking direction (both outer sides of the pair of the mounting plates 4 with respect to the zinc oxide elements 6). For example, the electrode 1 is formed in a circular disc shape in the same manner as the mounting plate 4. One of the pair of the electrodes 1 and one of the pair of the mounting plates 4 are arranged separately facing to each other in the stacking direction, and the other one of the pair of the electrodes 1 and the other one of the mounting plates 4 are arranged separately facing to each other in the stacking direction. On a surface of the electrode 1 facing the mounting plate 4, a plurality of fitting holes 31 are formed corresponding to the positions of the insertion holes 30. As described later, the other end portion of the tightening piece 2 is fitted into the fitting hole 31. An inner diameter of the fitting hole 31 is substantially constant in a depth direction. The depth of the fitting hole 31 is smaller than the thickness of the electrode 1.

A plurality of the insulting rods 3 are arranged around the serial member 20, which are extending along the stacking direction. The insulating rod 3 is formed in a shape of a rod with its radius (an outer diameter) constant in an extension direction, for example. The insulating rod 3 is formed with FRP (Fiber Reinforced Plastics), for example. In contrast to the insulating rod described in Japanese Patent Application Laid-open No. 2003-332108 and Japanese Patent Application Laid-open No. 2010-027671, a mechanically processed portion such as a drilled hole portion or a groove portion is not formed on the insulating rod 3 and its outer circumferential surface is substantially uniform. For example, a plurality of the insulating rods 3 are arranged around the serial member 20 at a regular interval. In the example shown in the drawings, six insulating rods 3 are arranged. The insulating rods 3 connect the paired electrodes 1 to improve the mechanical strength of the arrester.

Both end portions of the insulating rod 3 respectively pass through the insertion holes 30 of the pair of the mounting plates 4. Furthermore, each of the end portions of the insulating rod 3 is fitted into the tightening piece 2 that is formed in a substantially cylindrical shape having a bottom, thus being tightened and fixed. That is, by fitting the tightening piece 2 formed in a cylindrical shape having a bottom or a cap shape on each of the end portions of the insulating rod 3 and pressurizing and tightening the tightening piece 2 in a radial direction of the insulating rod 3, the paired tightening pieces 2 are respectively mounted on the both end portions of the insulating rod 3. In this manner, when the tightening piece 2 is caulked such that a plastic deformation occurs in the tightening piece 2, the end portion of the insulating rod 3 is also compressed, and as a result, the tightening piece 2 is fixed to the end portion of the insulating rod 3 by friction.

The tightening piece 2 fixed to each end portion of the insulating rod 3 is sandwiched by the mounting plate 4 and the electrode 1 in the stacking direction by one end portion being inserted into the insertion hole 30 of the mounting plate 4 and the other end being inserted into the fitting hole 31 of the electrode 1. Furthermore, an end surface of the one end portion of the tightening piece 2 inserted into the insertion hole 30 makes contact with a stepped portion (a bottom surface portion of the second inner diameter portion) that is a boundary between the first inner diameter portion and the second inner diameter portion. In addition, a side surface of the one end portion of the tightening piece 2 also makes contact with the mounting plate 4. On the other hand, an end surface of the other end portion of the tightening piece 2 inserted into the fitting hole 31 makes contact with a bottom portion of the fitting hole 31. Further, a side surface of the other end portion of the tightening piece 2 also makes contact with the electrode 1. The fitting hole 31 and the insertion hole 30 are arranged by being aligned at positions facing each other. In addition, an inner diameter of the fitting hole 31 and the second inner diameter of the insertion hole 30 are substantially the same.

Furthermore, the electrode 1 and the mounting plate 4 facing the electrode 1 are fastened by, for example, a bolt 5 as a fastening member. Specifically, for example, the bolt 5 is inserted into the mounting plate 4 from the side of the serial member 20, passes through the mounting plate 4, and its distal end portion is screwed into the electrode 1. An axial direction of the bolt 5 is parallel to the stacking direction. A plurality of bolts 5 are provided in a circumferential direction of the electrode 1 and the mounting plate 4. In the example shown in the drawings, six bolts 5 are provided alternately with the insulating rods 3 in the circumferential direction. By fastening the electrode 1 and the mounting plate 4 by the bolt 5, the tightening piece 2 is pressed and tightened in the stacking direction.

An outer cover 8 covers the serial member 20 and the insulating rods 3 in a direct and integral manner. The outer cover 8 is formed of an insulating resin material such as a polymer, for example, a silicon rubber. A plurality of corrugations are provided in a protruding manner on an outer circumferential surface of the outer cover 8 along the stacking direction. When a short-circuit current flows through the arrester, an arc gas of high temperature and high pressure is generated inside the arrester, an opening is formed on the outer cover 8 by the pressure of the arc gas, and the arc gas is discharged from this opening.

As described above, in the present embodiment, because the electrode 1 and the mounting plate 4 sandwiching the tightening piece 2 in the'stacking direction are fastened by the bolt 5, the tightening piece 2 is compressed in the stacking direction by an axial force of the bolt 5 and is solidly fixed between the electrode 1 and the mounting plate 4. With this configuration, each of the end portions of the insulating rod 3 to which the tightening piece 2 is fixed is also solidly fixed. In this case, the insulating rod 3 is not influenced by the axial force of the bolt 5, but only a tension load of the pressing spring 7 is applied to the insulating rod 3.

In this manner, each of the insulating rods 3 is mounted on the electrode 1 via the tightening piece 2, the mounting plate 4, and the bolt 5.

As explained above, in the present embodiment, each of the end portions of the insulating rod 3 is fixed, to which the tightening piece 2 is fixed, by sandwiching the tightening piece 2 mounted on the insulating rod 3 with the electrode 1 and the mounting plate 4 and compressing the tightening piece 2 in an axial direction (a stacking direction) by the axial force of the bolt 5 that fastens the electrode 1 and the mounting plate 4.

As described above, in the present embodiment, because there is not provided any load concentrating portion (mechanically processed portion) that may be a starting point of breakage when an excessive load is applied on the arrester, it is possible to constitute an arrester having a large mechanical strength without increasing the diameter of the insulating rod 3 or increasing the number of the insulating rods 3 to be installed.

In the polymer arrester described in Japanese Patent Application Laid-open No. 2003-332108, when an excessive load is applied on the arrester, the load may possibly lead to breakage of the insulating rod starting from the groove portion (the mechanically processed portion). Similarly, in the polymer arrester described in Japanese Patent Application Laid-open No. 2010-027671, when an excessive load is applied on the arrester, the load may possibly lead to breakage of the insulating rod starting from the drilled hole portion (the mechanically processed portion). In the configurations of the above conventional polymer arresters, in order to achieve an arrester having a larger mechanical strength, it is required to increase the diameter of the insulating rod or to increase the number of insulating rods to be installed. However, this may lead to an increase of the arrester in size and cost.

On the other hand, in the present embodiment, it is possible to achieve an arrester having a large mechanical strength with a compact size and a low cost.

Furthermore, because the tightening piece 2 mounted on each of the end portions of the insulating rod 3 is fixed by fastening the mounting plate 4 and the electrode 1 with the bolt 5, it is easy to assemble the arrester.

Although the tightening piece 2 is formed in a cylindrical shape having a bottom in the present embodiment, it can be formed in a tubular shape without a bottom, as long as it forms a configuration to sandwich the tightening piece 2 with the mounting plate 4 and the electrode 1 in the stacking direction.

### Second Embodiment

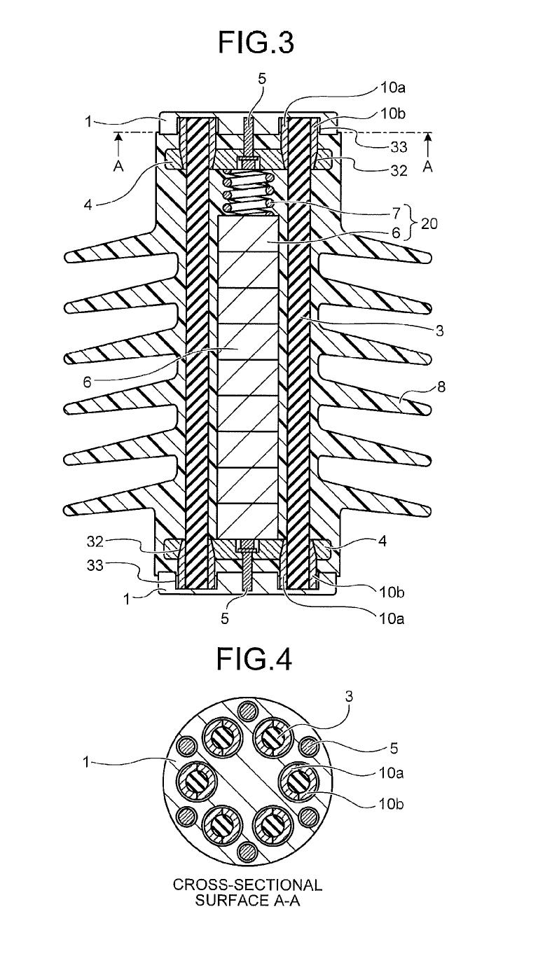

FIG. 3 is a vertical cross-sectional view of a configuration of an arrester according to a second embodiment of the present invention, and FIG. 4 is a horizontal cross-sectional view taken along a line A-A indicated by arrows in FIG. 3. In FIGS. 3 and 4, constituent elements same as those of the arrester shown in FIGS. 1 and 2 are denoted by like reference signs and redundant explanations thereof will be omitted, and only features of the second embodiment different from those of the first embodiment are explained below.

An insertion hole 32 into which an insulating rod 3 is inserted is provided on the mounting plate 4. For example, the insertion hole 32 is provided at a regular interval in a circumferential direction of the mounting plate 4 corresponding to the number of the insulating rods 3 (for example, six insulating rods in the example shown in the drawings). An inner diameter of the insertion hole 32 is decreased in a uniform manner from the side of the electrode 1 toward the side of the serial member 20, and the inner diameter closest to the side of the serial member 20 is substantially equal to an outer diameter of the insulating rod 3.

On a surface of the electrode 1 facing the mounting plate 4, a plurality of fitting holes 33 are formed corresponding to positions of the insertion holes 32. An inner diameter of the fitting hole 33 is substantially constant in a depth direction, which is substantially equal to the inner diameter of the insertion hole 32 closest to the side of the electrode 1. The depth of the fitting hole 33 is smaller than the thickness of the electrode 1.

Both end portions of the insulating rod 3 respectively pass through the insertion holes 32 of a pair of the mounting plates 4. Furthermore, on each of the end portions of the insulating rod 3, paired pieces 10a and 10b each formed substantially in a semicircular truncated cone shape are arranged to surround each of the end portions in a circumferential direction in such a manner that they form a substantially circular truncated cone shape as a whole and a small diameter side (a distal end side) of the circular truncated cone shape is arranged on the side of the serial member 20.

The pieces 10a and 10b have the same shape as each other, which is a shape obtained by bisecting a substantially circular truncated cone in its axial direction. Specifically, each of the pieces 10a and 10b is configured with a semicircular tubular portion of a substantially semicircular tubular shape arranged on the side of the electrode 1, and a semicircular truncated cone portion that is connected to the semicircular tubular portion and arranged on the side of the serial member 20 with its outer diameter being decreased in a uniform manner from the side of the electrode 1 toward the side of the serial member 20.

End portions of the paired pieces 10a and 10b on the side of the serial member 20 are fitted in between an outer circumferential surface of the insulating rod 3 inserted into the insertion hole 32 and in inner circumferential surface of the insertion hole 32. That is, because the outer diameter of the insulating rod 3 is constant in the axial direction (the stacking direction), in a state where an end portion of the insulating rod 3 is inserted into the insertion hole 32, there occurs a gap between the outer circumferential surface of the end portion and the inner circumferential surface of the insertion hole 32, and the end portions of the small diameter side (the distal end side) of the pieces 10a and 10b are fitted to fill in this gap. That is, the semicircular truncated cone portions of the pieces 10a and 10b are arranged in the mounting plate 4. In the mounting plate 4, the outer circumferential surfaces of the pieces 10a and 10b make contact with the inner circumferential surface of the insertion hole 32 and the inner circumferential surfaces of the pieces 10a and 10b make contact with the outer circumferential surface of the end portion of the insulating rod 3. Furthermore, the end portions of the small diameter sides (distal end sides) of the pieces 10a and 10b reach a surface of the mounting plate 4 on the side of the serial member 20.

Furthermore, end portions of the pair of pieces 10a and 10b on the side of the electrode 1 are fitted in between the outer circumferential surface of the end portion of the insulating rod 3 inserted in the fitting hole 33 and the inner circumferential surface of the fitting hole 33. That is, in a state where the end portion of the insulating rod 3 is inserted in the fitting hole 33, there occurs a gap between the outer circumferential surface of the end portion and the inner circumferential surface of the fitting hole 33, and end portions of a large diameter side (a base end side) of the pieces 10a and 10b are fitted to fill in this gap. That is, (parts of) the semicircular tubular portions of the pieces 10a and 10b are arranged in the electrode 1. In the electrode 1, the outer circumferential surfaces of the pieces 10a and 10b make contact with the inner circumferential surface of the fitting hole 33, the inner circumferential surfaces of the pieces 10a and 10b make contact with the outer circumferential surface of the insulating rod 3, and end surfaces of the pieces 10a and 10b on the side of the electrode 1 make contact with a bottom surface portion of the fitting hole 33.

Further, similarly to the first embodiment, the electrode 1 and the mounting plate 4 facing the electrode 1 are fastened by, for example, the bolt 5 as a fastening member. By the electrode 1 and the mounting plate 4 being fastened by the bolt 5 in the stacking direction, the pieces 10a and 10b are pressed and tightened in the stacking direction.

As described above, in the present embodiment, because the paired pieces 10a and 10b having a substantially semicircular truncated cone shape are arranged to surround the end portion of the insulating rod 3 and the electrode 1 and the mounting plate 4 sandwiching the pieces 10a and 10b in the stacking direction are fastened by the bolt 5, the pieces 10a and 10b are compressed in both directions including the stacking direction and a radial direction by an axial force of the bolt 5. Because the semicircular truncated cone portions of the pieces 10a and 10b are inclined with respect to the stacking direction, the pieces 10a and 10b are compressed by receiving a pressure in the radial direction toward the center of the insulating rod 3 by the axial force of the bolt 5 that is parallel to the stacking direction. Therefore, each end portion of the insulating rod 3 is fixed by the pieces 10a and 10b that are compressed toward the center of the radial direction by the axial force of the bolt 5. In addition, because the pieces 10a and 10b are also compressed in the stacking direction (the axial direction) by the axial force of the bolt 5, they are solidly fixed. In this state, the insulating rod 3 is not influenced by the axial force of the bolt 5, but only a tension load of the pressing spring 7 is applied to the insulating rod 3.

In this manner, each of the insulating rods 3 is mounted on the electrode 1 via the pieces 10a and 10b, the mounting plate 4, and the bolt 5.

In the present embodiment, similarly to the first embodiment, because there is not provided any load concentrating portion (mechanically processed portion) that may be a starting point of breakage when an excessive load is applied on the arrester, it is possible to constitute an arrester having a large mechanical strength without increasing the diameter of the insulating rod 3 or increasing the number of the insulating rods 3 to be installed.

In the present embodiment, by making the pieces 10a and 10b in a substantially semicircular truncated cone shape, it is possible to fix the pieces 10a and 10b without pressing and tightening the pieces 10a and 10b on the end portion of the insulating rod 3, thus making it possible to omit a caulking operation.

In the present embodiment, the end portions of the small diameter sides (distal end sides) of the pieces 10a and 10b reach the surface of the mounting plate 4 on the side of the serial member 20. With this configuration, the pressure in the radial direction by the axial force of the bolt 5 acts on the serial member 20 in a more effective manner, and as a result, the pieces 10a and 10b are more solidly fixed to the end portion of the insulating rod 3. However, even though the end portions of the small diameter sides (distal end sides) of the pieces 10a and 10b do not reach the surface of the mounting plate 4 on the side of the serial member 20, as far as the length of the circular truncated cone portion in the mounting plate 4 in the stacking direction is secured to a certain extent, it is possible to solidly fix the pieces 10a and 10b to the end portion of the insulating rod 3.

In the present embodiment, although a configuration is taken such that the paired pieces 10a and 10b each having a substantially semicircular truncated cone shape are arranged around the insulating rod 3, it is also possible to arrange three or more pieces that constitute a substantially circular truncated cone shape as a whole around the insulating rod 3. For example, it is possible to configure such that each of the pieces 10a and 10b is bisected in the axial direction and then four pieces are arranged to surround the end portion of the insulating rod 3. Other configurations, operations, and effects of the present embodiment are same as those of the first embodiment.

### Third Embodiment

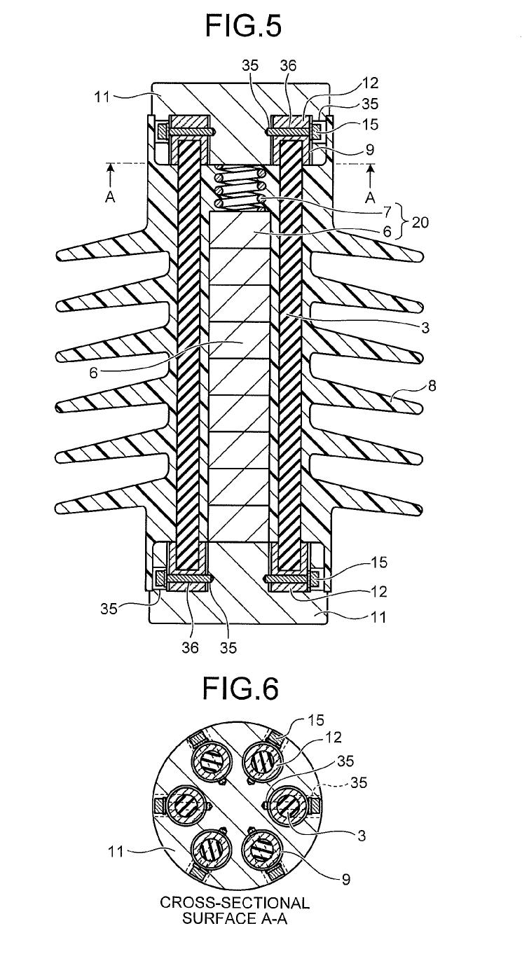

FIG. 5 is a vertical cross-sectional view of a configuration of an arrester according to a third embodiment of the present invention, and FIG. 6 is a horizontal cross-sectional view of the arrester taken along a line A-A indicated by arrows in FIG. 5. In FIGS. 5 and 6, constituent elements same as those of the arrester shown in FIGS. 1 and 2 are denoted by like reference signs and redundant explanations thereof will be omitted, and only features of the third embodiment different from those of the first embodiment are explained below.

In the present embodiment, unlike the first embodiment, the mounting plate 4 is not provided; however, a pair of electrodes 11 is arranged on respective ends of a stacking direction of the serial member 20 formed by a plurality of the zinc oxide elements 6 and the pressing spring 7. The pair of the electrodes 11 sandwiches the serial member 20. The electrode 11 is formed in a circular shape, for example. On a surface of the electrode 11 facing the serial member 20, a plurality of fitting holes 9 (electrode grooves) are formed corresponding to the positions of a plurality of insulating rods 3. The fitting hole 9 has a circular-shaped cross section and an inner diameter thereof is substantially constant in a depth direction. The depth of the fitting hole 9 is smaller than the thickness of the electrode 11. For example, the fitting holes 9 are provided at a regular interval in a circumferential direction of the electrode 11. The fitting holes 9 are respectively used to insert end portions of the insulating rods 3.

On the electrode 11, a bolt mounting hole 35 that passes through the fitting hole 9 from an outer circumferential surface (a side surface) of the electrode 11 is provided in perpendicular to an axial direction of the fitting hole 9 and cutting across an axis of the fitting hole 9 in a radial direction. The bolt mounting hole 35 is composed of a notched hole portion formed on the outer circumferential surface side of the electrode 11 and a screw hole portion formed on a center side of the electrode 11. The notched hole portion has a size enough to accommodate a head portion of a bolt 15.

Each of the end portions of the insulating rod 3 is fitted into a tightening piece 12 that is formed in a substantially cylindrical shape having a bottom, thus being caulked and fixed. That is, by fitting the tightening piece 12 formed in a cylindrical shape having a bottom on each of the end portions of the insulating rod 3 and pressurizing and tightening the tightening piece 12 in a radial direction of the insulating rod 3, the paired tightening pieces 12 are respectively mounted on the both end portions of the insulating rod 3. In this manner, when the tightening piece 12 is caulked such that a plastic deformation occurs in the tightening piece 12, the end portion of the insulating rod 3 is also compressed, and as a result, the tightening piece 12 is fixed to the end portion of the insulating rod 3 by friction.

Furthermore, on a bottom portion of the tightening piece 12, a through hole 36 (a notched hole portion) that passes through the tightening piece 12 in the radial direction is,provided. That is, the through hole 36 is provided in a bottom portion of the tightening piece 12 from an end surface of the insulating rod 3 without passing through the insulating rod 3.

The tightening piece 12 fixed to each end portion of the insulating rod 3 is arranged in a state where it is fitted into the fitting hole 9 and the bolt mounting hole 35 of the electrode 11 and the through hole 36 of the tightening piece 12 arc aligned. The bolt 15 is then inserted into the notched hole portion of the bolt mounting hole 35 and the through hole 36 of the tightening piece 12 from the outer circumferential surface of the electrode 11, and screwed into the screw hole portion of the bolt mounting hole 35. By tightening the bolt 15 in a state where the head portion of the bolt 15 and the electrode 11 sandwich the tightening piece 12, the tightening piece 12 is fixed to the electrode 11.

In the present embodiment, because the tightening piece 12 is compressed in the radial direction by an axial force of the bolt 15, it is solidly fixed with the electrode 11. Furthermore, the tightening piece 12 is fixed to the end portion of the insulating rod 3 by being caulked. In this case, the insulating rod 3 is not influenced by the axial force of the bolt 15, but only a tension load of the pressing spring 7 is applied to the insulating rod 3. In this manner, each of the insulating rods 3 is mounted on the electrode 1 via the tightening piece 12 and the bolt 15.

As described above, in the present embodiment, because there is not provided any load concentrating portion (mechanically processed portion) that may be a starting point of breakage when an excessive load is applied on the arrester, it is possible to configure an arrester having a large mechanical strength without increasing the diameter of the insulating rod 3 or increasing the number of the insulating rods 3 to be installed. Other configurations, operations, and effects of the present embodiment are same as those of the first embodiment.

According to the present invention, it is possible to provide an arrester having a larger mechanical strength without enlarging its size.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An arrester comprising:
a serial member including stacked voltage nonlinear resistor elements and a pressing spring that is arranged at one end of the voltage nonlinear resistor elements and presses the voltage nonlinear resistor elements in its stacking direction;
a plurality of insulating rods arranged around the serial member along the stacking direction each having a constant outer diameter, where end portions of each of the insulating rods are respectively fixed by being fitted into substantially cylindrical pieces each having a bottom and caulked by the pieces;
a pair of mounting plates respectively arranged on both ends of the serial member in the stacking direction and sandwiching the serial member, where each of the mounting plates has a plurality of insertion holes each being formed in a stepped shape such that an end portion of the insulating rod is inserted through and one end portion of the piece on a side of the serial member is fitted;
a pair of electrodes respectively arranged on both outer sides of the pair of mounting plates in the stacking direction, where each of the electrodes faces its corresponding mounting plate and is arranged separately from the mounting plate, and has a plurality of fitting holes into which other end portions of the pieces are respectively fitted; and
a bolt that fastens in the stacking direction the mounting plate, in which the end portions of the insulating rods respectively inserted into the insertion holes and the one end portions of the pieces are respectively fitted into the insertion holes, and the electrode, which faces the mounting plate with the other end portions the pieces respectively fitted into the fitting holes, and tightens the pieces in the stacking direction in a state where the pieces are sandwiched between the electrode and the mounting plate.

2. An arrester comprising:
a serial member including stacked voltage nonlinear resistor elements and a pressing spring that is arranged at one end of the voltage nonlinear resistor elements and presses the voltage nonlinear resistor elements in its stacking direction;
a plurality of insulating rods arranged around the serial member along the stacking direction each having a constant outer diameter, where end portions of each of the insulating rods are respectively surrounded by a pair of pieces each formed substantially in a semicircular truncated cone shape in such a manner that the paired pieces form a substantially circular truncated cone as a whole and a side of a small diameter of the circular truncated cone shape is arranged on a side of the serial member;
a pair of mounting plates respectively arranged on both ends of the serial member in the stacking direction and sandwiching the serial member, where each of the mounting plates has a plurality of insertion holes through which the end portions of the insulating rods inserted and inner diameters of which decrease in a uniform manner toward the side of the serial member such that one end portions of the pair of pieces are respectively fitted;
a pair of electrodes respectively arranged on both outer sides of the pair of mounting plates in the stacking direction, where each of the electrode faces its corresponding mounting plate and is arranged separately from the mounting plate, and has a plurality of fitting holes into which other end portions of the pieces are respectively fitted; and
a bolt that fastens in the stacking direction the mounting plate, in which the end portions of the insulating rods respectively inserted into the insertion holes and the one end portions of the pair of pieces are respectively fitted into the insertion holes, and the electrode, which faces the mounting plate with the other end portions the pieces respectively fitted into the fitting holes, and tightens the pieces in the stacking direction in a state where the pieces are sandwiched between the electrode and the mounting plate.

3. The arrester according to claim 2, wherein end portions on the side of the small diameter of the pair of pieces reach a surface of the mounting plate on the side of the serial member.

4. An arrestor comprising:
a serial member including stacked voltage nonlinear resistor elements and a pressing spring that is arranged at one end of the voltage nonlinear resistor elements and presses the voltage nonlinear resistor elements in its stacking direction;
a plurality of insulating rods arranged around the serial member along the stacking direction each having a constant outer diameter, where end portions of each of the insulating rods are respectively fixed by being fitted into substantially cylindrical pieces each having a bottom and caulked by the pieces;
a pair of electrodes respectively arranged on both outer sides of the pair of mounting plates in the stacking direction, where each electrode has a plurality of fitting holes into which other end portions of the pieces on the end portions of the insulating rod are respectively fitted; and
a bolt that passes through a bottom portion of the piece inserted into the fitting hole in a radial direction from a side surface of the electrode and is screwed into the electrode, and tightens and fixes the piece to the electrode in the radial direction.

5. The arrester according to claim 1, wherein any mechanical processed portion, which is a drilled hole portion or a groove portion, is not formed on each of the insulating rods.

6. The arrester according to claim 2, wherein any mechanical processed portion, which is a drilled hole portion or a groove portion, is not formed on each of the insulating rods.

7. The arrester according to claim 3, wherein any mechanical processed portion, which is a drilled hole portion or a groove portion, is not formed on each of the insulating rods.

8. The arrester according to claim 4, wherein any mechanical processed portion, which is a drilled hole portion or a groove portion, is not formed on each of the insulating rods.
